(19) United States
(12) Patent Application Publication
(10) Pub. No.: US 2026/0228866 A1
(43) Pub. Date: Aug. 6, 2026

(54) DEPTH CAMERA NOISE MODEL

(71) Applicant: Commonwealth Scientific and Industrial Research Organisation, Acton ACT (AU)

(72) Inventors: Fahira AFZAL MAKEN, Acton ACT (AU); Chuong NGUYEN, Acton ACT (AU); Changming SUN, Acton ACT (AU); Sundaram MUTHU, Acton ACT (AU)

(73) Assignee: Commonwealth Scientific and Industrial Research Organisation, Acton ACT (AU)

(21) Appl. No.: 19/464,960

(22) Filed: Jan. 30, 2026

(30) Foreign Application Priority Data
Jan. 31, 2025 (AU) 2025900261

(51) Int. Cl. G06T 5/70; G06T 7/50; G06T 7/80; G06V 10/30

(52) U.S. Cl. CPC G06T 5/70; G06T 7/50; G06T 7/80; G06V 10/30; G06T 2207/10028; G06T 2207/20024; G06T 2207/20182

(57) ABSTRACT

The present invention provides a method for generating a noise model for a depth camera, the method including, in one or more processing devices: acquiring data from the depth camera, the data being captured by performing measurements of a reference surface at multiple different known depths, wherein for each known depth, data are captured at multiple different known surface angles; analysing the data captured at each known depth at each known surface angle to calculate measurement errors indicative of variations in depth measurements; and, calculating a noise model by fitting the measurement errors to at least one function representing relationships between measurement errors and, measurement depths and surface angles, as a combination of bivariate exponential and bivariate polynomial functions, wherein the noise model is usable in analysing depth measurements performed using the depth camera.

### BACKGROUND OF THE INVENTION

The present invention relates to a system and method for generating a noise model for a depth camera, and a system and method for depth sensing using a depth camera and associated noise model.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Depth sensing is important in perceiving the environment in three dimensions. With depth cameras providing rich 3D information, they have become integral to vision systems across manufacturing industries, facilitating various applications including 3D object segmentation, pose estimation, 3D reconstruction and scene understanding. Depth cameras enable creation of accurate 3D models for printing, surface inspection, or part repair in reverse modelling. Specifically, advanced digital manufacturing applications including metrology, quality inspection, autonomous repair, 3D printing, and others, require high resolution scanning with low measurement uncertainty and sub-mm level accuracy in the 3D reconstruction of the scanned objects. This is important to capture fine details, achieve tight tolerances, meet dimensional specifications, or achieve the required surface finishing.

However, none of the raw depth values from the current depth cameras on the market are capable of achieving reliably sub-mm accuracy in the 3D reconstruction of scanned objects required for high-precision manufacturing applications. This limitation stems from the noisy depth maps, characterized by high measurement uncertainty, which results from a combination of systematic errors (inherent to the system and imaging principle), and non-systematic errors (caused by unknown environmental factors).

Systematic errors originate from the sensing methodology involved, such as structured light, time of flight, or stereo depth cameras. Calibration of the sensors is typically performed to reduce the effect of systematic errors to some extent. Non-systematic errors originate from environmental conditions such as lighting conditions, the reflectivity of the target objects, measurement distance, and the angle between the object's surface normals and the principal axis of the camera.

To this end, approaches have empirically modelled the noise characteristics of well-known low cost RGB-D (color (RGB) and depth (D)) sensors such as Microsoft Kinect and Intel RealSense, and one such example is described in “Modeling Kinect sensor noise for improved 3D reconstruction and tracking” by Chuong V Nguyen, Shahram Izadi, and David Lovell, 2012 Second International Conference on 3D Imaging, Modeling, Processing, Visualization & Transmission, pages 524-530. IEEE, 2012.

In addition, “Kinect v2 for mobile robot navigation: Evaluation and modeling” by Peter Fankhauser, Michael Bloesch, Diego Rodriguez, Ralf Kaestner, Marco Hutter, and Roland Siegwart, 2015 International Conference on Advanced Robotics (ICAR), pages 388-394. IEEE, 2015 characterizes the influence of the ambient light for indoor, overcast, and direct sunlight situations considering the sunlight incidence angle. “Evaluation of the Azure Kinect and its comparison to Kinect v1 and Kinect v2 Sensors” by Michal Tolgyessy, Martin Dekan, Lubos Chovanec, and Peter Hubinsky, 21(2): 413, 2021, extends the analysis to include Azure Kinect, examining its noise characteristics during warming up, reflectivity levels, pixel positions, and under outdoor lighting conditions.

However, these approaches have limitations in terms of accuracy. It is desired, therefore, to overcome or alleviate one or more difficulties of the prior art, or to at least provide a useful alternative.

### SUMMARY OF THE PRESENT INVENTION

Aspects of the present invention are set out in the accompanying claims.

In one aspect, there is described a method for generating a noise model for a depth camera, the method including, in one or more processing devices: acquiring data from the depth camera, the data being captured by performing measurements of a reference surface at multiple different known depths, wherein for each known depth, data are captured at multiple different known surface angles; analysing the data captured at each known depth at each known surface angle to calculate measurement errors indicative of variations in depth measurements; and, calculating a noise model by fitting the measurement errors to at least one function representing relationships between measurement errors and, measurement depths and surface angles, as a combination of bivariate exponential and bivariate polynomial functions, wherein the noise model is usable in analysing depth measurements performed using the depth camera.

In another exemplary aspect, the method includes, in the one or more processing devices, analysing the data to calculate measurement errors for at least one of: a part of the surface aligned with an imaging axis of the depth camera so that the noise model is an axial noise model; and, parts of the surface spaced from the imaging axis of the depth camera so that the noise model is a lateral noise model.

In another exemplary aspect, the method includes, in the one or more processing devices: analysing the data to calculate measurement errors indicative of variations in depth measurements spaced from the imaging axis of the depth camera; and, calculating the lateral noise model by fitting the measurement errors to at least one lateral noise function.

In another exemplary aspect, the method includes, in one or more processing devices: acquiring data from the depth camera using multiple different known imaging parameters, wherein for each known imaging parameter images are captured at multiple different known depths, and wherein the imaging parameters include at least one of: lighting conditions; an image exposure time; a number of images captured; depth camera aperture settings; depth camera resolution settings; and, depth camera dynamic range settings; analysing the data captured for each imaging parameter at each known depth to calculate measurement errors indicative of variations in depth measurements; and, calculating an imaging parameter noise model by fitting the measurement errors to at least one imaging parameter function.

In another exemplary aspect, the method includes, in the one or more processing devices, analysing the data to calculate measurement errors for at least one of: a part of the surface aligned with an imaging axis of the depth camera so that the imaging parameter noise model is an axial noise model; and, parts of the surface spaced from the imaging axis of the depth camera so that the imaging parameter noise model is a lateral noise model.

In another exemplary aspect, the method includes, in the one or more processing devices, determining the imaging parameters using at least one of: the data; camera data indicative of depth camera operation; user input commands; and signals from one or more additional sensors.

In another exemplary aspect, the reference surface includes a planar surface.

In another exemplary aspect, the measurement errors are calculated based on differences between depth measurements and a plane fitted to the planar surface.

In another exemplary aspect, the reference surface is rotatably supported, and the method includes rotating the reference surface to orientate the reference surface at each of the different known surface angles.

In another exemplary aspect, the method includes in the one or more processing devices, controlling the turntable to position the reference surface at the known surface angles.

In another exemplary aspect, the depth camera is movably mounted relative to the reference surface, and the method includes moving the depth camera to position the depth camera at each of the different known depths.

In another exemplary aspect, the depth camera is movably mounted using a robot arm, and the method includes in the one or more processing devices, controlling the robot arm to position the depth camera at the known depths.

In yet another aspect, there is described a method for obtaining depths using a depth camera, the method including, in one or more processing devices: acquiring data from the depth camera, the data being captured by performing measurements of a surface; for a point on the surface, analysing the data to calculate an estimated depth and a corresponding estimated surface angle; and, using at least one function of a noise model to calculate an error in the estimated depth based on the estimated depth and corresponding estimated surface angle, wherein the at least one function represents relationships between measurement errors and, measurement depths and surface angles as a combination of bivariate exponential and bivariate polynomial functions.

In another exemplary aspect, the method includes, in the one or more processing devices: for a point on the surface aligned with a camera axis, calculating the error in the estimated depth using an axial noise model; and, for a point on the surface spaced from a camera axis, calculating the error in the estimated depth using a lateral noise model.

In another exemplary aspect, the data includes data captured from different viewpoints and the method includes, in the one or more processing devices: for a point on the surface, analysing the data from captured from multiple different viewpoints to obtain multiple estimated depths and corresponding estimated surface angles; using at least one function of the noise model to calculate an error associated with each estimated depth based on the estimated depth and the corresponding estimated surface angle; and, using the error to assigning a weighting to each estimated depth, the weighting having a magnitude indicative of the error calculated for the estimated depth.

In another exemplary aspect, the method includes, in the one or more processing devices: determining an imaging parameter, wherein: the imaging parameter includes at least one of: lighting conditions; an image exposure time; a number of images captured; depth camera aperture settings; depth camera resolution settings; an depth camera dynamic range; and, using at least one function of an imaging parameter noise model to calculate an error in an estimated depth based on the estimated depth and the imaging parameter.

In another exemplary aspect, the method includes, in the one or more processing devices, using the error to at least one of: estimate an error for a measured depth for the point on the surface; track movement of the depth camera relative to the surface; reconstruct the surface; perform coverage planning when scanning the surface; perform filtering when reconstructing the surface; perform a SLAM process; generate a surface point cloud; and, perform object recognition or classification.

In another exemplary aspect, the method includes: analysing the data to: construct a surface model of the surface; and, determine a pose of the depth camera relative to the surface; and, using the noise model to account for sensor noise and thereby: construct a refined surface model indicative of the surface of the object; and, determined a refined pose of the sensor relative to the object.

In another exemplary aspect, method includes, in the one or more processing devices: generating the surface model using estimated depths obtained from data captured from one of multiple different viewpoints; and, iteratively updating the surface model using estimated depths obtained from data captured at successive ones of the multiple different viewpoints to construct the refined surface model.

In another exemplary aspect, the method includes, in the one or more processing devices, iteratively updating the surface model using a weighting scheme in which weights are assigned to estimated depths based on errors calculated using the noise model.

In another exemplary aspect, the weighting scheme is used to filter the surface model to reduce the impact of noisy data on the refined surface model.

In another exemplary aspect, the method includes, in the one or more processing devices: generating a voxel grid; iteratively populating the voxel grid with depth data derived from data captured from different viewpoints using a weighting scheme; and, generating the surface model using the populated voxel grid.

In another exemplary aspect, the method includes, in the one or more processing devices, tracking depth camera pose by performing an alignment between with the voxel grid populated using data captured from a previous viewpoint using depth data derived from the depth camera.

In other aspects, there are described apparatus and systems configured to perform the methods as described above. In a further aspect, a computer program is described, comprising machine readable instructions arranged to cause a programmable device to carry out the described methods.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:—

FIG. 1 is a schematic diagram of an example of a system for generating a noise model for a depth camera;

FIG. 2 is a flowchart of an example of a method for generating a noise model for a depth camera;

FIG. 3 is a flowchart of an example of a method for using a depth camera using an associated noise model;

FIG. 4 is a schematic diagram of a further example of a system for generating a noise model for a depth camera;

FIGS. 5A and 5B are a flowchart of a further example of a method for generating a noise model for a depth camera;

FIG. 6 is a flowchart of a further example of a method for generating a noise model for a depth camera;

FIG. 7A is an image of an example of a reconstructed first surface generated without noise correction;

FIG. 7B is an image of an example of a reconstructed first surface generated with noise correction;

FIG. 7C is an image of an example of a reconstructed second surface generated with noise correction;

FIG. 7D is an image of an example of a reconstructed second surface generated without noise correction;

FIG. 8 is an image of a specific example of a system for generating a noise model for a depth camera;

FIG. 9A is a graph of an example of changes in axial noise for different depths and different surface angles;

FIG. 9B is a graph of an example of a noise model using a 7^{th} order bivariate polynomial;

FIG. 9C is a graph of an example of a noise model using a bivariate exponential function plus a 2^{nd} order bivariate polynomial;

FIG. 9D is an image of an example of a noise model encoded as a bi-linearly interpolated image;

FIGS. 10A to 10F are graphs of examples of lateral noise measurements for a lateral noise model;

FIG. 11 is a graph of examples of lateral noise measurements for different depths and surface angles;

FIGS. 12A to 12C are graphs of examples of axial noise measurements for different imaging parameters;

FIGS. 12D to 12F are graphs of examples of lateral noise measurements for different imaging parameters;

FIG. 13A is an image of an example experimental setup for scanning a first model;

FIG. 13B is an RGB image captured using the setup of FIG. 13A;

FIG. 13C is a depth image captured using the setup of FIG. 13A;

FIG. 13D is an image of an example experimental setup for scanning a second model;

FIG. 13E is an RGB image captured using the setup of FIG. 13D;

FIG. 13F is a depth image captured using the setup of FIG. 13D;

FIGS. 14A to 14C are images of example 3D surface reconstructions obtained with different pose parameters while all other parameters remain the same;

FIG. 15 is an image of an example of the KinectFusion algorithm, with a noise model incorporated to enhance the TSDF values for improved depth fusion;

FIG. 16A is an image of an example surface model of a first object obtained without noise filtering;

FIG. 16B is an image of an example surface model of the first object obtained with noise filtering;

FIG. 16C is an image of an example surface model of the first object obtained using a traditional approach;

FIG. 16D is an image of an example surface model of a second object obtained without noise filtering;

FIG. 16E is an image of an example surface model of the second object obtained with noise filtering;

FIG. 16F is an image of an example surface model of the second object obtained using a traditional approach;

FIGS. 17A to 17D are graphs of examples of sensor movement tracking;

FIG. 18A is an image of an example of a model constructed from the Shiva dataset using Point-SLAM baseline approach;

FIG. 18B is an image of an example of a model constructed from the Shiva dataset using noisy depth filtering; and,

FIG. 18C is an image of an example of a model constructed from the Shiva dataset using a depth loss term using a noise model.

### DETAILED DESCRIPTION OF THE PREFERRED EMBODIMENTS

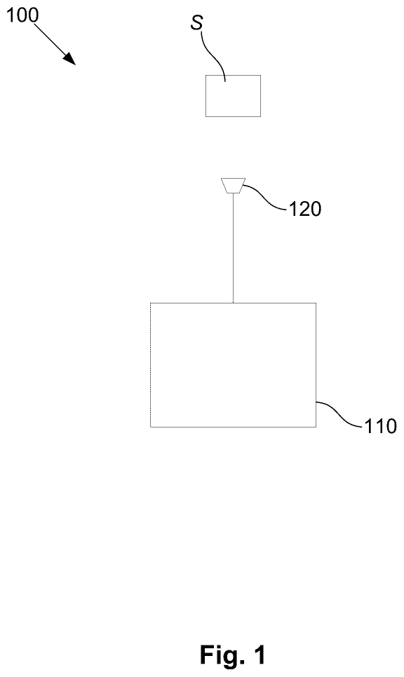

An example of a system for generating a noise model for a depth camera will now be described with reference to FIG. 1.

In this example, the system 100 includes one or more processing devices 110 connected to a depth camera 120. The nature of the depth camera will vary depending on the preferred implementation, but typically the depth camera is an RGB based depth camera that provides both depth (D) and color (RGB) data as an output, optionally merged into a single frame. A wide variety of camera types exist, such as a structured light cameras, time of flight cameras, or the like, which is used to capture RGBD information regarding a surface S.

When generating a noise model for a depth camera, the surface S is typically a reference surface having a known configuration, such as a planar calibration surface, or similar. For the purpose of noise modelling, the position of the depth camera 120 can be adjusted relative to the surface S, specifically to alter a depth representing a distance between the depth camera 120 and the surface S, whilst the relative surface angle between the depth camera 120 and the surface S can also be adjusted, typically by altering a rotation of the surface S, as will be described in more detail below.

For the purpose of illustration, it is assumed that the one or more electronic processing devices form part of one or more processing systems, such as computer systems, servers, or the like. Furthermore, for ease of illustration the remaining description will refer to a processing device, but it will be appreciated that multiple processing devices could be used, with processing distributed between the processing devices as needed, and that reference to the singular encompasses the plural arrangement and vice versa.

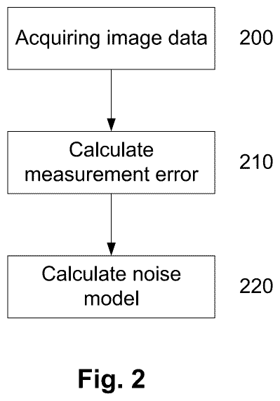

An example of a method for generating a noise model for a depth camera will now be described with reference to FIG. 2.

In this example, at step 200, the processing device 110 acquires data from the depth camera 120, with the data being captured by performing measurements of the reference surface S captured at multiple different known depths. The nature of the data will vary depending on the preferred implementation and the output format of the camera, but typically this will include RGB-D images, although this is not essential and other forms of data could be used.

For each known depth, data are also captured at multiple different known surface angles. Known depths could be provided at a fixed spacing, such as every 20 mm, with measurements being performed over a usual operating range of the depth camera, such as between 200 mm and 1200 mm, or the like, depending on the sensor and its intended application. Similarly, known angles could be at a fixed angular separation, such as every 5° or 10°, with measurements being performed between 0° and 80°, and optionally ±80°. However, it will be appreciated that this is intended to be illustrative only and different measurement regimes could be used depending on the nature of the sensor and the intended application.

The measurements can be performed in any suitable manner, and in one example this is achieved by progressively moving the depth camera to different distances from the reference surface to thereby provide the known depths. At each distance, data are then captured as the reference surface is rotated, to thereby provide the different known surface angles. This provides a straightforward mechanism for rapidly capturing data at multiple known depths and known relative surface angles, but it will be appreciated that other approaches could be used. For example, the depth camera could be statically mounted and the reference surface moved to provide the different known depths, or the depth camera could be moved around the reference surface to capture different angles. Specific arrangements to achieve the required positioning will be described in more detail below.

At step 210, the processing device calculates a measurement error indicative of variations in depth measurements for each measured depth, meaning a measurement error is calculated at each known surface angle for each known depth. The measurement error can be calculated in any appropriate manner. For example, this could be achieved based on a difference between the measured depth and the known depth. For example, if the depth is 100 mm and the measured depth is 105 mm, then there is a 5 mm error in the measured depth. More typically however, this is achieved by comparing measured depths to expected measured depths based on a surface model of the calibration surface S. For example, if the surface S is a planar surface, plane fitting can be used to calculate deviations between measured depths and the plane of the surface.

At step 220, the processing device calculates a noise model by fitting the measurement errors to at least one function representing relationships between measurement errors and, the measurement depths and surface angles. Due to the variability of the response of the sensor to different depths and different surface angles, it is preferable to ensure the function is able to capture the impact of errors over a range of different surface angles and depths. For example, errors will generally increase as surface angles increase, and as depth increase. However, the increase in error is not typically linear, meaning basic functions are insufficient to accurately represent the relationship between the depth and surface angles and the corresponding error. Accordingly, in one preferred example, the function typically includes one or more of an n^{th} order bivariate polynomial function (where n is at least 3 and more typically 7), a combination of bivariate exponential [e.g. represents non-linear effect from out of focus] and bivariate polynomial [e.g. represents camera's quadratic physics effect] functions, or a bivariate exponential function plus a 2^{nd} order bivariate polynomial. The function(s) then form the basis of a noise model that is usable in correcting depth measurements performed using the depth camera.

Accordingly, the above described approach provides a mechanism for generating a noise model, which can correct noise in depth measurements performed over a range of different depths and relative surface angles. Furthermore, it has been identified that using equations of the type described above provides a good balance between ensuring accuracy of the calculated error, whilst maintaining a limit on computational complexity, ensuring noise corrections can be performed substantially in real time, which is important for some applications, such as localising moving objects within an environment as part of mapping and/or control applications.

It will be noted that whilst noise models may be generated on a per depth camera basis, this is not essential, and depending on the manufacturing specifications of the depth camera, it may be possible to use noise models across multiple identical depth cameras, such as sensors manufactured as part of a single batch or similar, depending on the degree of variability between camera sensors. In any event, as the above described process can be performed automatically by controllably moving the reference surface and/or depth camera, as will be described in more detail below, this allows noise models for depth cameras to be rapidly generated as needed, allowing for per sensor noise models to be generated if required.

A number of further features of the process for generating a noise model will now be described.

In one example, the processing device analyses the data to calculate the measured depth for a part of the surface aligned with an imaging axis of the depth camera so that the noise model is an axial noise model. This allows noise to be calculated for depth measurements that are performed aligned to the imaging axis of the depth camera (referred to as on-axis measurements).

Additionally and/or alternatively, depending on the intended application, the processing device analyses the data to calculate the measured depth for parts of the surface spaced from the imaging axis of the depth camera so that the noise model is a lateral noise model. This allows noise to be calculated for depth measurements that are performed offset from the imaging axis of the depth camera (referred to as off-axis measurements). In this regard, it will be appreciated that in many scenarios, such as when generating a surface model of an object, images contain both on-axis and off-axis depth information. Typically, off-axis depth measurements are subject to greater noise and hence uncertainty than on-axis measurements, and so use of separate noise models for on-axis and off-axis measurements can allow information from across images to be utilised, whilst ensuring relevant errors are accounted for.

In one example, to generate an off-axis noise model the processing device can analyse the data to calculate measurement errors indicative of variations in depth measurements spaced from the imaging axis of the depth camera. Following this, the processing device can calculate a lateral noise model by fitting the measurement errors to at least one lateral noise function.

In a further example, a noise model can be derived for different imaging parameters, such as lighting conditions, image exposure times, number of images captured, depth camera aperture settings, depth camera resolution settings, depth camera dynamic range settings, or the like. In this example, the processing device acquires data from the depth camera using multiple different known imaging parameters, with images being captured at multiple different known depths for each known imaging parameter. Following this, the data can be analysed to calculate measurement errors indicative of variations in depth measurements. The measurement errors can then be used to calculate an imaging parameter noise model by fitting the measurement errors to at least one imaging parameter function. It will be appreciated that a respective noise model can be derived for each imaging parameter, allowing models to account for changes in illumination, depth camera settings, or other imaging parameters.

In this situation, the imaging parameter models can include on-axis and off-axis depth measurements, so as to develop axial and lateral noise models. Specifically, by analysing depth measurements for a part of the surface aligned with an imaging axis of the depth camera, the resulting imaging parameter noise model is an axial noise model, whereas analysing depth measurements for parts of the surface spaced from (and hence offset from) the imaging axis of the depth camera the imaging parameter noise model is a lateral noise model.

The imaging parameters can be determined in any one of a number of ways. For example, these can be determined from the data and/or separate sensor data, where the imaging parameters correspond to settings of the depth camera. Alternatively, these can be based on user input commands, signals from one or more additional sensors, or the like, depending on the nature of the imaging parameters and the preferred implementation.

In one example, the reference surface includes a planar surface. The use of a planar surface is advantageous as this simplifies the calculation process, particularly in terms of identifying variations in depth measurements relative to a known or calculated configuration of the surface. For example, this can be achieved by calculating measurement errors based on differences between each depth measurement and a plane fitted to the planar surface. However, it will be appreciated that this is not essential and any other suitable surface and/or method for calculating measurement errors could be used.

In one example, the reference surface is rotatably supported, for example using a turntable other similar arrangement, in which case the method includes rotating the reference surface to orientate the reference surface at each of the different known surface angles, for example by having the processing device control the turntable to position the reference surface at the known surface angles. This allows the relative angle between the surface and the depth camera to be rapidly and accurately controlled, ensuring the process is accurate, and can be performed quickly.

Similarly, the depth camera can be movably mounted relative to the reference surface allowing the depth camera to be positioned at each of the different known depths. In one example, this is achieved by having the depth camera movably mounted using a robot arm, with the processing device controlling the robot arm to position the depth camera at the known depths. Again, this allows the distance between the surface and the depth camera to be rapidly and accurately controlled, ensuring the process is accurate, and can be performed quickly.

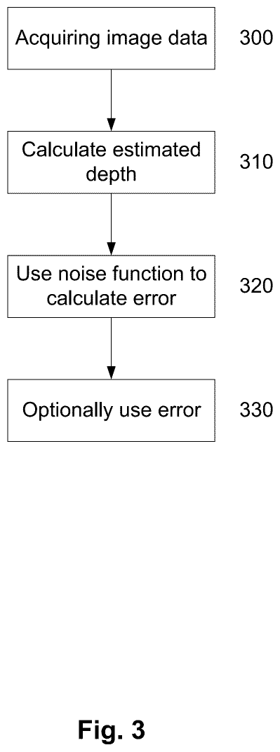

An example of a method for using a noise model associated with a depth camera will now be described with reference to FIG. 3.

It will be noted that whilst this example uses a similar hardware configuration to that shown in FIG. 1, there is no requirement for this to be the same processing device and surface as used in the calibration process. Indeed, the depth camera can be used in a wide range of applications, such as mapping applications, in which the surface may form part of an object, an environment, or similar.

In this example, at step 300, the processing device acquires data from the depth camera. This can be achieved in any one of a number of manners, and may include scanning the surface, by moving the surface and depth camera relative to each other, so that images of the surface can be captured from different viewpoints. This might occur as the depth camera traverses an environment, or might involve an arrangement similar to that described above in which a depth camera and object are moved relative to each other, to allow a surface of the object to be scanned, enable a surface model to be constructed.

At step 310, for a point on the surface, the processing device analyses the data to calculate an estimated depth and a corresponding estimated surface angle. This is achieved using the depth camera in accordance with normal operation and will not therefore be described in further detail.

At step 320, the processing device uses at least one function of a noise model to calculate an error in the estimated depth. As described above, the function represents relationships between measurement errors and, measurement depths and surface angles. Accordingly, this can be achieved by providing the estimated depth and corresponding estimated surface angle as inputs to the function, allowing an estimated error to be calculated.

The error can then optionally be used at step 330, for example to refine depth estimates of the point on the surface, enabling more accurate depth determination to be performed. This in turn enables more accurate surface scanning and/or depth camera positioning to be achieved.

Example uses of the error include, but are not limited to calculating a measured depth for the point on the surface, tracking movement of the depth camera relative to the surface, reconstructing the surface, performing coverage planning when scanning the surface, performing filtering when reconstructing the surface, performing a SLAM (Simultaneous Localisation and Mapping) process, generating a surface point cloud, performing object recognition or classification, or the like.

A number of further features of the process for using a noise model associated with a depth camera will now be described.

In one example, the processing device is configured to take into account if the point on the surface is on-axis or off-axis, for the image under consideration. Specifically, the processing device analyses the data and for a point on the surface aligned with a camera axis, calculates the error in the estimated depth using an axial noise model. Conversely, for a point on the surface spaced from a camera axis, the processing device calculates the error in the estimated depth using a lateral noise model.

Typically, the data is captured from different viewpoints, for example as a result of movement of the depth camera and/or surface. In this case, the processing device analyses the data from multiple different viewpoints to calculate multiple estimated depths and corresponding estimated surface angles, for any given point. The processing device can use at least one function of the noise model to calculate an error associated with each estimated depth based on the estimated depth and the corresponding estimated surface angle, with this optionally being achieved using an axial or lateral noise model, depending on whether the point is on or off axis in the respective image being analysed. Once this has been completed, the errors are used to assigning a weighting to each estimated depth, with the weighting having a magnitude indicative of the error calculated for the estimated depth. The processing device then uses the weighted estimated depths to calculate a depth for the point on the surface relative to a given viewpoint.

Thus, this approach uses a weighting scheme based on the error for each measurement calculated using the noise model. By capturing multiple images of points on the surface and then taking into account the weightings assigned to each measurement, this can allow a more accurate measure of the depth of any one point (relative to an arbitrary viewpoint) to be calculated.

In addition to accounting for the depth, surface angle, and on or off axis measurements, other imaging parameters can be taken into account, such as those described above. In this example, the processing device determines the imaging parameter and then uses at least one function of an imaging parameter noise model to calculate an error in an estimated depth based on the estimated depth and the imaging parameter.

In one example, the processing device is configured to analyse the data to construct a surface model indicative of the surface and/or determine a pose of the depth camera relative to the surface, using the noise model to account for sensor noise and thereby construct a refined surface model indicative of the surface of the object and/or determined a refined pose of the sensor relative to the object.

In one particular example, the processing device is configured to generate an initial surface model using estimated depths calculated from one of a plurality of different viewpoints. The processing device can then iteratively update the surface model using estimated depth from successive ones of the plurality of images to construct the refined surface model. This is typically performed by iteratively updating the surface model using a weighted average scheme in which weights are assigned to estimated depths based on errors calculated using the noise model. This approach can help filter the surface model to reduce the impact of noisy data on the refined surface model, for example by configuring the weighting scheme so that any measurements for which there is a likelihood of a large error contribute minimally to the overall surface model.

In one specific example, the processing device is configured to generate a voxel grid, and then iteratively populate the voxel grid with depth data derived from successive images using a weighted average scheme, allowing a surface model to be generated using the populated voxel grid. This approach allows individual images to be analysed in turn, with depth measurements derived from each image to be progressively incorporated into the surface model using the weighted average scheme, so that accuracy of the surface model progressively increases. This allows users to balance the computational complexity of analysing the images with the desired level of accuracy in the model.

As part of this, the processing device tracks depth camera pose for an image by performing an alignment between with the voxel grid populated using previous images using depth data derived from the image. The processing device can also apply uncertainty weighting and ground truth depth refinement using the noise model.

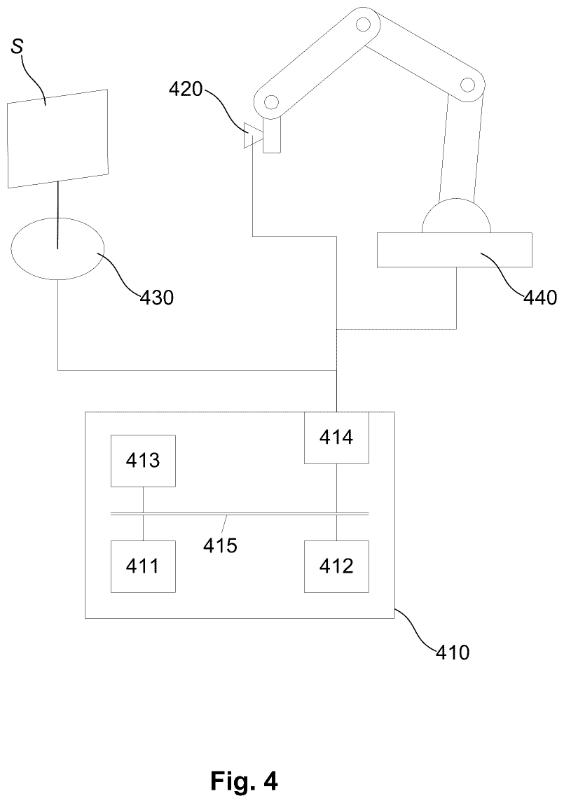

A specific example of apparatus for generating a noise model for a depth camera is shown in FIG. 4.

In this example, the apparatus includes a turntable 430, which supports the reference surface S, allowing the reference surface to be rotated. The apparatus further includes a robot arm 440, which holds the depth camera 420, allowing a position of the depth camera 420 relative to the surface to be adjusted. The apparatus further includes a processing system 410, which is configured to control the turntable 430 and robot arm 440, as well as to receive and process images from the depth camera 420.

In this example, the processing system 410 includes at least one microprocessor 411, a memory 412, an optional input/output device 413, such as a keyboard and/or display, and an external interface 414, interconnected via a bus 415, as shown. In this example the external interface 414 can be utilised for connecting the processing system 410 to peripheral devices, such as communications networks, databases, other storage devices, or the like, as well as the depth camera 420, the turntable 430, and the robot arm 440. Although a single external interface 414 is shown, this is for the purpose of example only, and in practice multiple interfaces using various methods (e.g., Ethernet, serial, USB, wireless or the like) may be provided.

In use, the microprocessor 411 executes instructions in the form of applications software stored in the memory 412 to allow the required processes to be performed. The applications software may include one or more software modules, and may be executed in a suitable execution environment, such as an operating system environment, or the like.

Accordingly, it will be appreciated that the processing system 410 may be formed from any suitable processing system, such as a suitably programmed client device, PC, server, or the like. In one particular example, the processing system 410 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

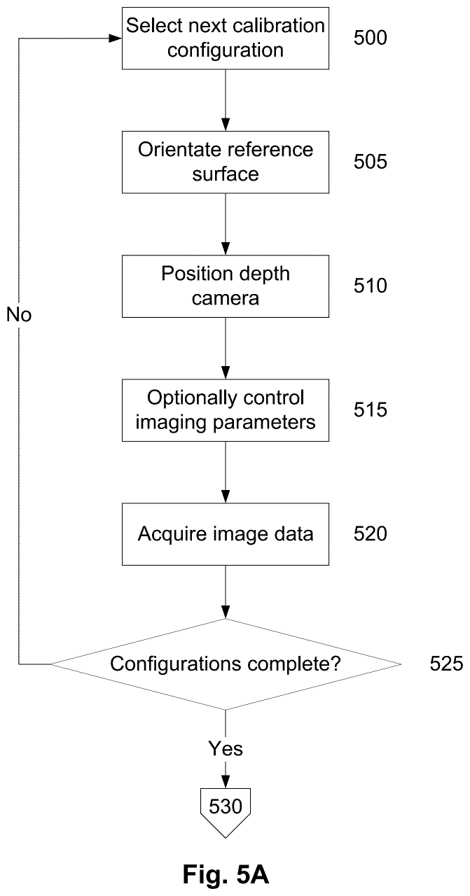

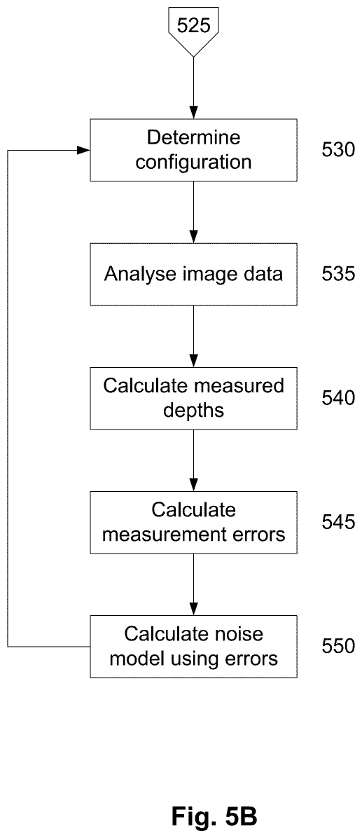

An example of the process for generating a noise model will now be described in more detail with reference to FIGS. 5A and 5B.

In this example, at step 500 a next calibration configuration is selected by the processing system 410. Typically this will include selecting a known depth and known surface angle, and may also optionally involve selecting one or more imaging parameters, if the noise model is also to take these into account. Generally the configuration is selected from a predefined sequence, defining the relevant depth/surface angle/imaging parameter combinations that need to be captured based on the requirements of the depth camera and/or application for which the sensor is to be used.

At step 505, the processing system 410 controls the turntable 430 to orientate the reference surface, controlling the robot arm 440 at step 510 to position the depth camera relative to the surface. At step 515 the processing system 410 can control imaging parameters, for example controlling settings of the depth camera, altering ambient illumination, or the like.

At step 520 data is acquired by having the depth camera capture an image of the surface. At step 525 the processing system 410 determines if all the different required configurations are complete, and if not, the process can return to step 500 allowing the above process to be repeated as needed.

Once required data have been captured, data processing can commence. It will be appreciated that this might occur once all data are captured, but that this is not essential and instead the capturing and processing of data can be performed in parallel, and this will be described in further detail below.

In any event when processing images, at step 530, the processing system 410 determines the configuration for the data being processed, allowing the processing system 410 to determine the depth and surface orientation, and optionally any other imaging parameters, associated with the captured data. At step 535, the processing system 410 analyses the data, allowing the processing system 410 to calculate measured depths at step 540, with these being used to calculate a measurement error for each respective measurement at step 545.

This process is repeated until it is determined that all, or sufficient images have been analysed, at which point the processing system 410 can calculate the noise model using the errors at step 550. A specific example of this will be described in more detail below.

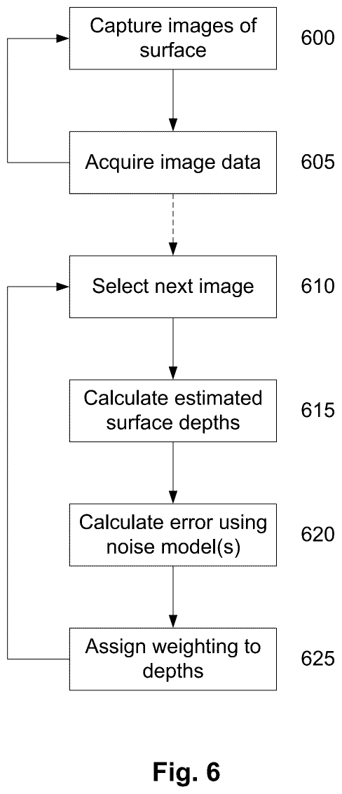

An example of the process for calculating a depth of a surface, for example to allow a depth camera position relative to the surface, or to allow surface reconstruction to be performed, will now be described with reference to FIG. 6.

In this example, at step 600, the depth camera 420 is positioned relative to a surface, allowing data to be acquired from a particular viewpoint with these being provided to the processing system 410 at step 605. This is typically repeated for multiple viewpoints by repeating steps 600 and 605. For example, if the surface is a surface of a small object, this could be placed on the turntable 430 of the apparatus described above, allowing multiple images of the object to be captured at different orientations as the object is progressively rotated. Alternatively, this could involve capturing images as a depth camera is moved through an environment or similar.

At step 610, the processing device 410 selects data from a next viewpoint, and then calculates estimated surface depths and angles for one or more points on the surface at step 615. It will be appreciated that for each viewpoint, this will typically include calculating depths and angles for multiple points on the surface, typically including a combination of both on-axis and off-axis points.

At step 620, the processing system 410 calculates surface depth errors for the points using respective noise models, including axial noise models for on-axis points and lateral noise models for off-axis points. At step 625, the processing system 410 uses the errors to assign weightings to the estimated depths. This process can then be repeated for multiple images by repeating steps 610 to 625, allowing the processing system 410 to calculate multiple weighted depths for different points on the surface, which can then be used, for example, to generate a surface model. For example, this might involve excluding some of the estimated depths having a lower accuracy, and then using weightings to govern measured depths contribution to a final calculated depth.

A specific example of experiments conducted to demonstrate the effectiveness of the above described approach will now be described in further detail.

For the purpose of this example, experiments were performed using a depth camera in the form of a Zivid sensor, which is a newer high-resolution 3D structured-light camera whose noise characteristics have not yet been extensively studied. The following aims to model the noise characteristics of the Zivid sensor to optimize its utility in object scanning applications. Specifically, in this example, axial noise (in the direction of the principle axis of the camera) and lateral noise (in the directions perpendicular to the axis of the camera) are quantified to assess how these components vary with object depth and surface angle. Additionally, the influence of lighting conditions, exposure time, and the number of captures on sensor performance are evaluated. The determined axial noise may also be adjusted based on the determined lateral noise. This may be advantageous in configurations where lateral noise captured by a particular camera sensor is dependent on the direction of the structured light projected into the scene. For example, the structure light may have one pixel resolution along the edge direction of the projected pattern (as measured for axial noise) but may have several pixels steps in the perpendicular direction to the edges. Depending in the settings on the camera (e.g. fast/slow, high/low quality), the number of pixels across the gap between the edges can be determined, and may be factored into adjustment of the determined axial noise for the pixels in the gap in the perpendicular direction to the edges.

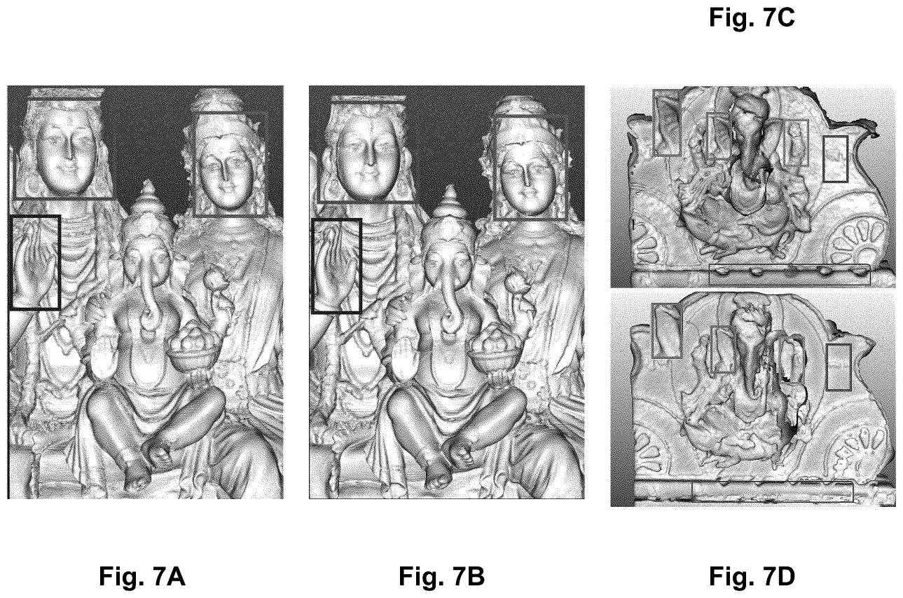

In order to showcase the use of noise modelling to improve downstream tasks, examples are provided of improving the task of 3D reconstruction by utilizing the noise model. To this end, the noise model is integrated in both traditional methods such as KinectFusion and modern neural-based approaches like Point-SLAM, described further in “Point-SLAM: Dense neural point cloud-based SLAM”, by Erik Sandstrom, Yue Li, Luc Van Gool, and Martin R Oswald from Proceedings of the IEEE/CVF International Conference on Computer Vision, pages 18433-18444, 2023. Filtering noisy depth values using the noise model not only improves the quality of 3D reconstruction but also captures high resolution details, as demonstrated in FIGS. 7A to 7D.

In this regard, FIGS. 7A to 7D show the noise model, when integrated into the KinectFusion algorithm described in “KinectFusion: real-time 3D reconstruction and interaction using a moving depth camera” by Shahram Izadi, David Kim, Otmar Hilliges, David Molyneaux, Richard Newcombe, Pushmeet Kohli, Jamie Shotton, Steve Hodges, Dustin Freeman, Andrew Davison, et al., from Proceedings of the 24th Annual ACM Symposium on User Interface Software and Technology, pages 559-568, 2011.2. In this example, the images of FIGS. 7A and 7D show a reconstructed surface without noise correction, whilst FIGS. 7B and 7C show the same surfaces reconstructed using noise correction. The highlighted boxes show improved quality of the surface reconstruction, specifically capturing high-resolution details, which are absent without noise correction.

There is a notable absence of high precision RGB-D dataset for the sub-mm level 3D reconstruction. To fill this gap, a new dataset was captured with the Zivid camera mounted on a robotic arm. This dataset features objects with intricate geometry, scanned from multiple viewpoints achieved by rotating both the object on a rotating turntable and the camera on a robot arm with high precision.

For improving 3D scanning in advanced manufacturing, the approach was used to empirically model axial and lateral noise characteristics of a high resolution RGB-D Zivid sensor as a function of measurement distance and surface angle of scanned objects. The approach was also used to provide insights on the performance under different lighting conditions, exposure time, and different capture settings. Following this, resulting noise models were used in 3D reconstruction pipelines from traditional to neural-based methods to improve both the quality of 3D reconstruction and pose estimation.

### Noise Modelling

Depth measurement errors in structured light sensors can occur due to sensor warm-up, varying distances, angles, binning modes, reflectivity, and distortion. In the following a noise model is characterised in three dimensions as a function of both depth distance z and surface angles θ. Specifically, noise characteristics are quantified in terms of axial noise (σ_{Z}=ƒ(z,θ)): [symbol] × [symbol] → [symbol] , which denotes noise along the principal axis of the camera, and lateral noise (σ_{L}=g(z,θ)): [symbol] × [symbol] → [symbol] , representing noise in directions perpendicular to the camera's axis. Furthermore, the performance of the Zivid sensor is considered under different lighting conditions, exposure times, and various capture settings.

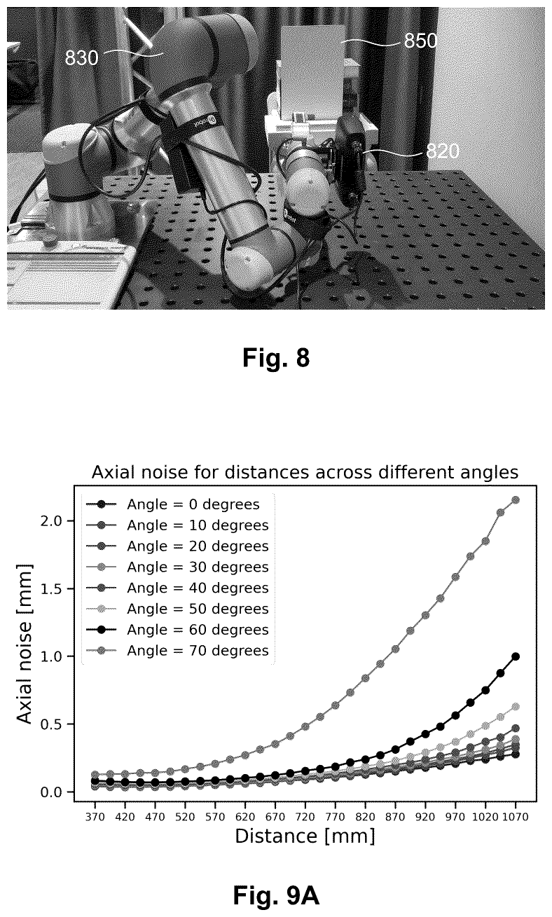

The experimental setup used to collect data for estimating the noise functions ƒ and g is shown in FIG. 8 and includes a robot arm 830, depth camera 820 and a planar target 850, which is a calibration board that has a dimensional accuracy of 10 μm. The planar target as well as the axis of rotation of the planar target are both perpendicular to the principle z-axis of the camera. The depth camera 820 is a Zivid Two structured light RGB-D camera. The camera is aligned to focus on the plane center of the target. The target is capable of rotating freely around the vertical axis. The camera is mounted on the robot arm, specifically a UR5e robot arm, to automate data collection precisely, reducing manual labour. An eye-in-hand calibration step is performed to determine the transformation between the camera and the robot base, ensuring accurate pose estimates of the Zivid camera within a global coordinate system.

During the experiment the following parameters are varied to model various noise characteristics of the sensor.

Distance z: The distance between the target and the camera is varied from 37.5 cm to 107.0 cm in steps of 2.5 cm. This axial movement of the camera is performed by moving the robot arm towards and away from the target in a straight line perpendicular to the planar target.

Surface angle θ: The angle of the planar target is varied from 0° to 90° in steps of 10°. The axis of rotation is perpendicular to the principal axis of the camera.

Lighting conditions: The data collection process involves scans of the target under both light and dark conditions at a surface angle of 0°, for all distances.

Exposure time: The exposure time or the duration of shutter opening time is varied from 1677 ms to 100 s.

Number of captures: The number of captures is varied from 1 to 5, combining multiple acquisitions with different apertures and enable capture at a high dynamic range.

### Axial Noise

Axial noise refers to depth measurement errors that vary along the sensor's viewing axis characterized by deviation of points from a plane fitted to the scan of the planar target.

Plane fitting is performed by extracting a clean surface of the calibration target from the scan, excluding boundaries to eliminate lateral noise effects and other unwanted effects such as specular reflections. Subsequently, a plane is fitted to the clean extracted surface, and errors are estimated between the fitted plane and the surface points. This process is repeated for all distances covered by the captured point clouds, across all the angles ranging from 0° to 70°. Given a set of N points

$$P = {\{ {p}_{i} \}}_{i = 1}^{N}$$

from an extracted clean point cloud, where pᵢ=(xᵢ, yᵢ, zᵢ)∈ [symbol] , at a distance z and angle θ with respect to the Zivid camera, the plane fitting aims to find the coefficients X={a, b, c, d} such that the plane equation ax+by+cz+d=0 best fits the given points in the least square sense.

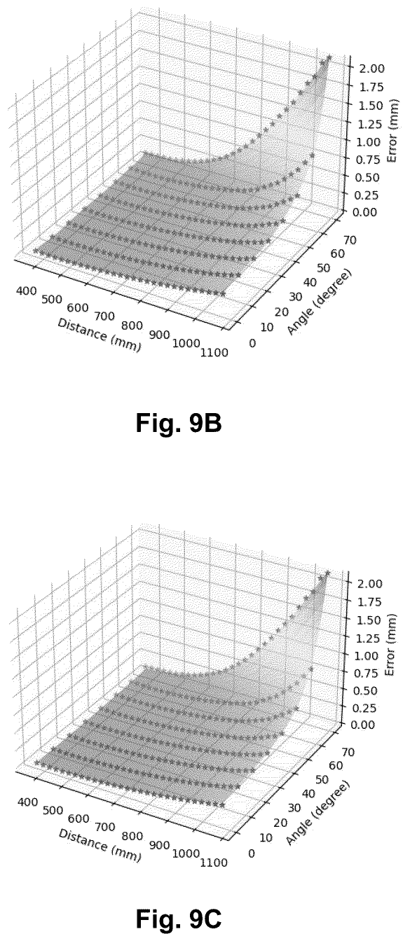

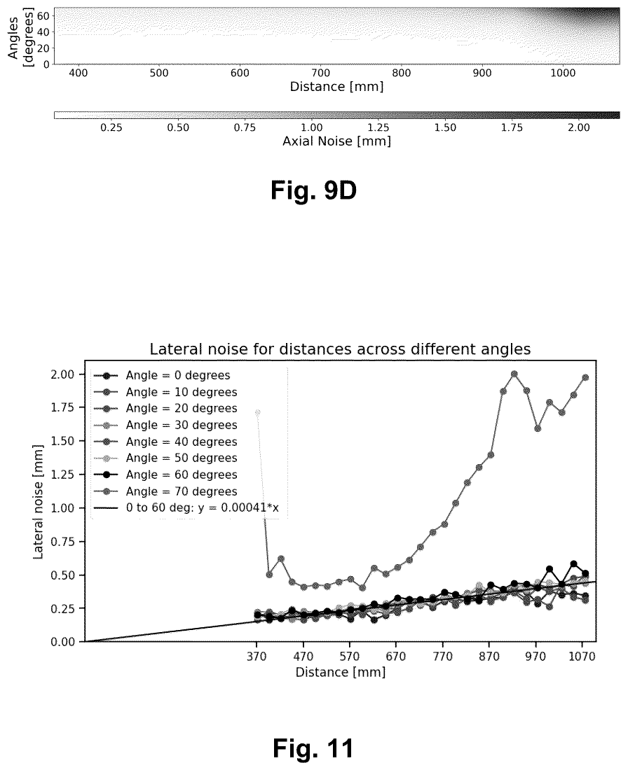

The axial noise for a single scan can then be computed as a root mean square distance between the fitted plane coefficients and the points. FIG. 9A shows axial noise values as a function of depth and angles. Axial noise is more pronounced at larger distances for angles 50° or more. The noise exhibits a non-linear trend, increasing as both the surface distance and surface angle increases. To capture this non-linear trend, three distinct methods are applied to fit a function to the noise curves in FIG. 9A, ensuring a simplified and interpretable explanation.

Polynomial fitting is used to fit surface models for the axial noise data displayed in FIG. 9A. The model used in FIG. 9B is represented as

$${f}_{1} ( z , θ ) = {\sum }_{i = 0}^{7} {\sum }_{j = 0}^{7 - i} {a}_{ij} {z}^{i} {θ}^{j} ,$$

requiring 36 coefficients on aᵢⱼ for a precise fit.

Polynomial and exponential fitting is performed using both polynomials and exponential terms in the fitting to handle distortions and distance variations. The model used in FIG. 9C is ƒ₂(z,θ)=Se^{Az}^{²}^{+Bzθ+Cθ}^{²}^{+Dz+Eθ}+az²+bzθ+cθ²+dz+eθ+ƒ, with {S, A, B, C, D, E, a, b, c, d, e, ƒ} being the coefficients, such that there are still 12 coefficients for ƒ₂(z, θ).

Due to the complexity of higher order coefficients in both fitted surfaces, an interpolated look-up image is generated as an alternate, as shown in FIG. 9D, whose pixels store values of the axial noise obtained in FIG. 9A. By employing bilinear interpolation, noise values are interpolated for any combination of distance and surface angle. This resulting axial noise image can easily be queried into downstream applications, such as KinectFusion, to obtain the noise value corresponding to a given distance and angle to achieve better 3D reconstruction.

### Lateral Noise

Lateral noise refers to depth measurement errors that occur along the directions perpendicular to the camera's axis that mainly looks at edge pixels of the planar target scan.

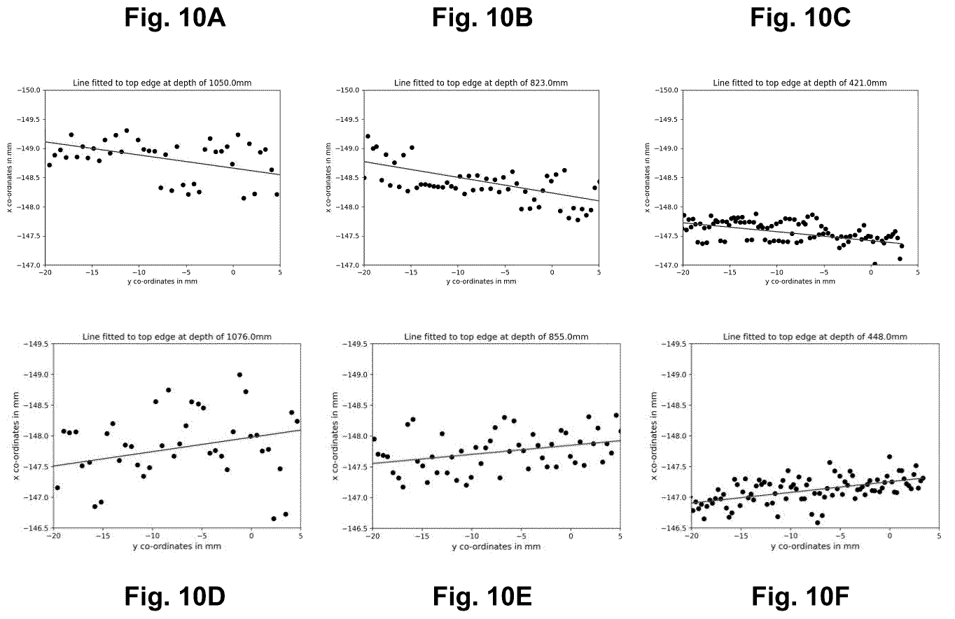

Line fitting is performed to model lateral noise as shown in FIGS. 10A to 10F. Firstly, background pixels are removed from images of the planar target. Then, the position of the top edge pixels of the planar target in the depth map are located. The number of pixels is limited to the middle 200 points of the top edge to avoid the effects of optical distortion. Subsequently, line fitting is performed on the x and y coordinates of the extracted edge pixel points. σ_{L} is then calculated as the root mean square distances between the edge pixel coordinates and the fitted line.

The fitted lateral noise model procedure is repeated for all scans obtained across distances and angles ranging from 0° to 80°. Ideally, a single line should adequately represent all edge pixel coordinates, but due to lateral noise effects, this is not always the case. FIGS. 10A to 10F show that the spread of the points around the fitted line decreases with decreasing distances. It is observed that the lateral noise is independent of the surface angles from 0° to 60°, but increases significantly for 70° to 80° indicating the reduced reliability of measurements at extreme surface angles. FIG. 11 shows the linear model fit to lateral noise σ_{L} as a function of surface distance.

### Imaging Parameters

The impact of other imaging parameters is explored by varying lighting conditions, exposure times, and capture settings on the axial and lateral noise as functions of distance.

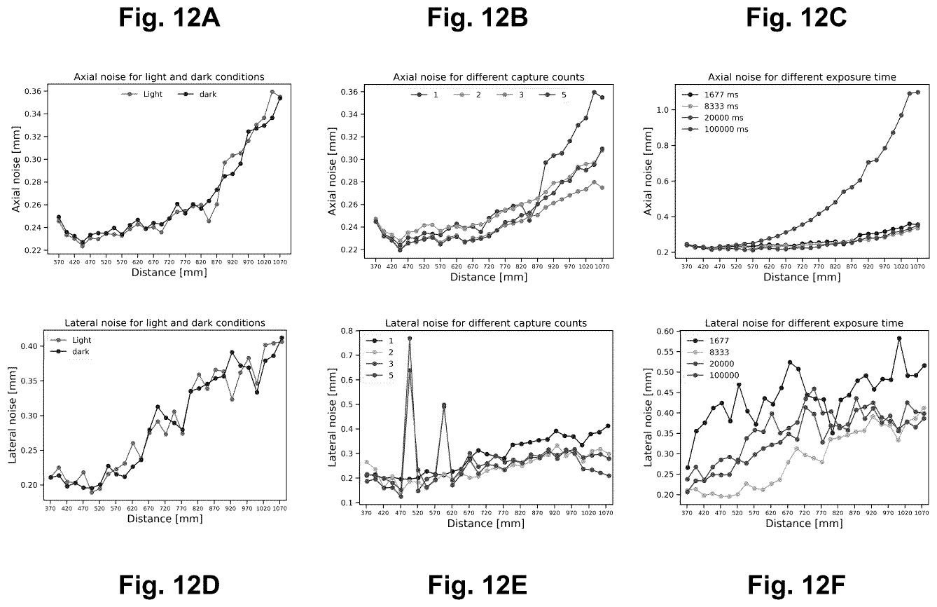

FIGS. 12A and 12D show that both axial and lateral noise are independent of the background lighting since the light emitted by the structured light sensor is much stronger comparison to ambient background lighting.

FIGS. 12B and 12E show that the quality of the scans can be improved by increasing the number of captures each with different aperture settings to capture with high dynamic range.

FIGS. 12C and 12F show that increased exposure time leads to decreased lateral noise due to the smoothing effect at depth edges. However, for axial noise, the quality of the depth images gets degraded for extended exposure time due to sensor saturation.

### Improved 3D Reconstruction

To validate the effectiveness of the noise model, a dataset is captured using a configuration similar to that shown in FIG. 8, with a depth camera mounted on a robot arm, but with objects placed on a turntable. The noise model was integrated into both traditional and implicit neural-based 3D reconstruction methods to improve both the quality of 3D reconstruction and pose estimation. The main focus is to demonstrate the superior reconstruction quality achieved using traditional KinectFusion known for their reliability over modern neural-based reconstruction methods. Additionally, the method is applied to modern techniques to illustrate its broad applicability in improving reconstruction outcomes across different methodologies.

### Datasets

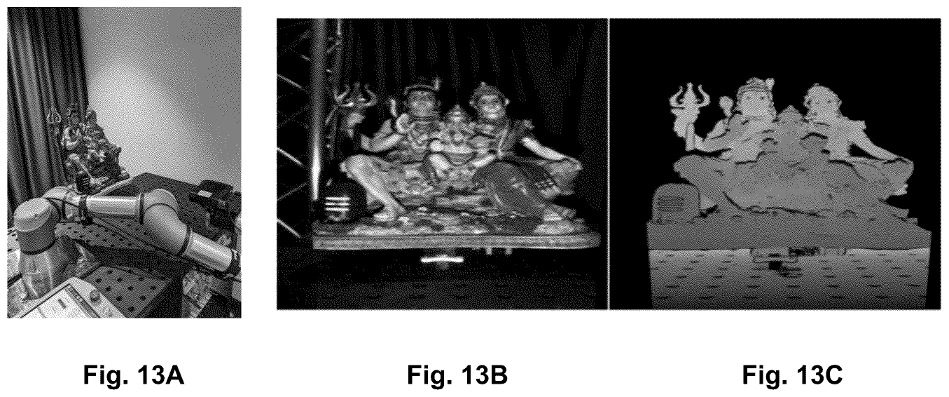

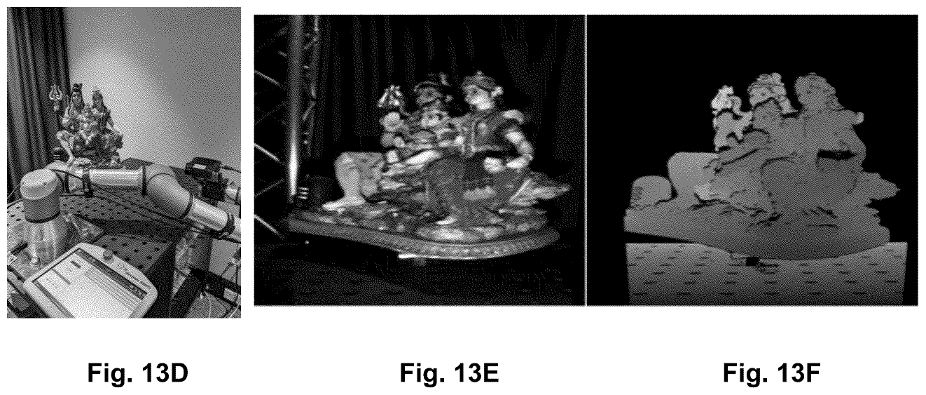

In the experimental setup, a variety of test objects are scanned using the above described setup, specifically using the Zivid camera, a motorized turntable, and a UR5e robotic arm. The test objects included a diverse array of items: cultural artifacts (Shiva and Ganesh), toy models (Dino and Dragon), and precision-engineered components (Gripper and Controller), as depicted in FIGS. 13A to 13F.

The scanning process involved rotating each object on the turntable with an incremental step of 1°. At each step, the Zivid camera captured an RGB-D image, resulting in a total of 360 images per object along a circular path. This precise rotational increment facilitates the effectiveness of camera tracking algorithms, which often operate under the assumption of small angular changes. Consequently, the dataset generated provides comprehensive ground truth information, enabling quantitative comparisons for each scanned object.

In order to obtain a baseline for 3D reconstruction for the dataset, traditional ICP (Iterative Closest Point) registration was used for pose estimation and fusing multiple point clouds followed by Poisson reconstruction for generating a mesh. Initially point cloud data were filtered using a statistical outlier removal algorithm. Then pair-wise data registration was performed using ICP to obtain the transformation parameters between two consecutive camera poses. Global pose graph optimisation approaches can be further applied to improve registration. A subset of the whole point cloud data was chosen for merging to reduce the data size. Finally, Poisson 3D surface reconstructions were performed on the obtained data.

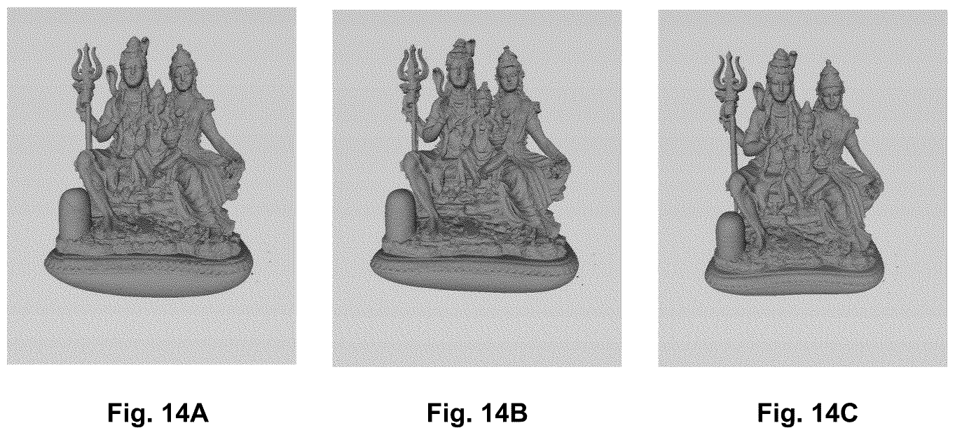

FIGS. 14A to 14C show the 3D surface reconstructions obtained with different pose parameters while all other parameters remain the same. FIG. 14A shows the surface reconstruction with pair-wise camera pose estimation starting from pose 1. There was a small error accumulation when combining all the poses. FIG. 14B shows the surface reconstruction with updated poses to minimise the accumulated pose error based on the poses from FIG. 14A. Although the error accumulation between pose 1 and pose 360 was reduced, there are pose deviations for other poses. FIG. 14C shows the surface reconstruction with pair-wise camera pose estimation starting from a different pose. It appears that the reconstruction shown in this subfigure achieved a better object surface comparing those in FIG. 14A and FIG. 14B because of the better pose connection between pose 1 and pose 360.

### Improving KinectFusion Using a Noise Model

Following previous similar approaches, the noise model was integrated into the KinectFusion algorithm to improve the approximation of the truncated sign distance function (TSDF) for each voxel in the voxel grid. KinectFusion iteratively fuses depth data from an RGB-D camera to a voxel grid structure stored on the GPU (Graphics Processing Unit). Within this grid, surface details are implicitly encoded as signed distances, truncated to a predefined layer containing the expected surface of an object. The integration of new depth values into the voxel grid employs a weighted average scheme. The global pose of the camera is tracked through a linearized ICP algorithm (using small angle assumption) by aligning the current frame with the accumulated model. The implicit surface can be extracted by either ray-casting the voxel grid or triangulating a mesh using marching cubes. Supposing a 2D pixel coordinate on the depth map is denoted as u=(x, y). Dᵢ(u) is the depth value at pixel u retrieved at the ith frame. With an intrinsic calibration matrix K, which is typically a 3×3 matrix containing the camera's focal lengths and optical center, a 3D vertex of the pixel u is νᵢ(u)=Dᵢ(u)K⁻¹[u, 1]. Here, K⁻¹ is the inverse of the intrinsic matrix K, and [u, 1] is the homogeneous coordinate representation of the pixel u. Dᵢ therefore results in a single vertex map Vᵢ. which represents the 3D points for all pixels at the ith frame. The camera pose of the ith frame is represented as Tᵢ=[Rᵢ, cᵢ], where Rᵢ is the rotation matrix and cᵢ is the translation vector, which describes the position and orientation of the camera relative to the world coordinate system. The vertex position is expressed in global coordinates as ν_{gi}=Tᵢ·νᵢ, where ν_{gi} is the transformed vertex in the global coordinates, and Tᵢ·νᵢ applies the rotation and translation to the 3D point νᵢ. The normal vector nᵢ(pₖ) at a point pₖ in 3D space represents the direction perpendicular to the surface at that point. It is used to calculate the angle, θ, between the z-axis and the normal, allowing surface data to be weighted based on the orientation of the depth measurement, with smaller angles indicating more reliable contributions to the updated TSDF.

The Algorithm 1 shown in FIG. 15 describes the KinectFusion algorithm, with a noise model incorporated to enhance the TSDF (Truncated Signed Distance Field) values for improved depth fusion. Specifically, the TSDF calculation at line 26 of the algorithm is designed to generate values within the range of [−1, 1]. In contrast to previous approaches, where a uniform weight, w, is assigned to all depth measurements regardless of their noise levels for reconstruction updates, this issue is addressed by assigning weights to depth measurements based on their noise quality and distance from the camera, as shown in Line 27 of Algorithm 1. The exponential term represents the weight of the noise distribution. σ_{z}(zₘᵢₙ) represents the axial noise value at the minimum depth (zₘᵢₙ) used in the noise modeling process.

In another example, by skipping lateral noise, which requires iteration over the 3×3 neighbourhood, this significantly speeds up runtime (≈9 times) with a small performance drop.

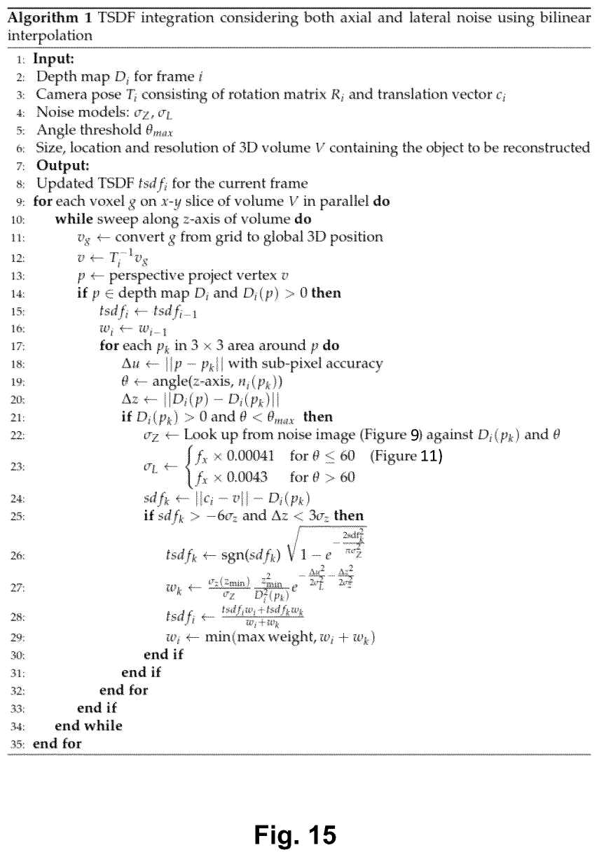

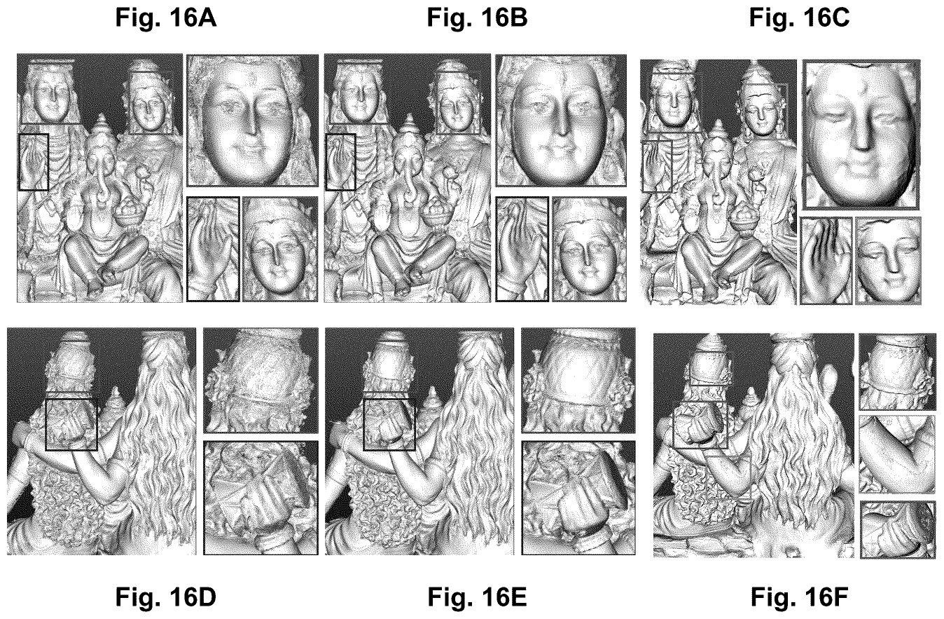

FIGS. 16B and 16E illustrate the substantial improvement in the reconstruction quality with the KinectFusion algorithm using the noise model compared with the results obtained without noise filtering shown in FIGS. 16A and 16D and with a more traditional 3D reconstruction pipeline shown in FIGS. 16C and 16F.

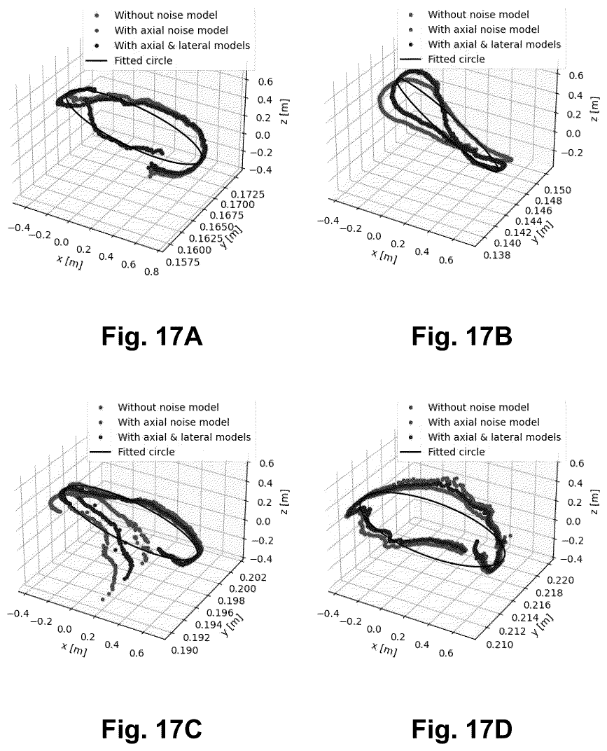

This depth filtering using the noise model also improves tracking, as shown in FIGS. 17A to 17D, where reduced drift in the trajectory is observed when depth is filtered. The decreased drift for the noisy depth filtering case is evident from the minimal difference between the start and end poses of the camera for 360° rotations which is significantly large when noisy depth measurements are not filtered. The corresponding RMSE (Root Mean Square Error) between the ground truth poses and the trajectories obtained with and without noise filtering are presented in the Table 1. The ground truth poses were obtained from the calibrated rotating table and robot arm set up which were further refined by fitting circular plane on the rotating axis.

Table 1 provides drift measurements (both distance and angle) as a quantitative comparison between different reconstruction conditions (without noise, with axial noise, and with both axial and later noise models) for 5 datasets. The reconstruction with noise models gains significant improvements for Shiva, Controller and Rock, although it slightly under-performs reconstruction without noise models for Dragon and Dino.

Most of the time, reconstruction with just axial noise performs close to that with both axial and lateral noise models, except for very smooth objects, and at a significant speed-up of about 9 folds.

TABLE 1

| Objects | No noise | Axial noise | Axial-lateral noise |
|---|---|---|---|
| Shiva | (0.00613, 0.42107) | (0.00184, 0.12915) | (0.00178, 0.12375) |
| Controller | (1.13467, 33.417) | (1.08114, 48.397) | (0.00579, 0.58854) |
| Rock | (0.00240, 0.31135) | (0.00086, 0.13408) | (0.00080, 0.10139) |
| Dragon | (0.00250, 0.41372) | (0.01116, 1.7199) | (0.00820, 1.2446) |
| Dino | (0.01085, 1.159) | (0.01121, 1.1883) | (0.01131, 1.2041) |

Table 2 provides a quantitative evaluation of the Gripper mesh across four cases, reconstructed using ground-truth poses, compared with the ground-truth mesh. It emphasizes the critical role of depth map filtering using the empirically derived noise models in applications demanding submillimeter-level accuracy.

TABLE 2

| Baseline | | | Without Noise | | |
|---|---|---|---|---|---|
| Prec.↑ | Rec.↑ | F↑ | Prec.↑ | Rec.↑ | F↑ |
| 0.154 | 0.435 | 0.228 | 0.361 | 0.479 | 0.412 |
| Axial Noise | | | Axial-Lateral Noise | | |
| Prec.↑ | Rec.↑ | F↑ | Prec.↑ | Rec.↑ | F↑ |
| 0.382 | 0.485 | 0.427 | 0.385 | 0.482 | 0.428 |

### Improving Neural Implicit SLAM Using Our Noise Model

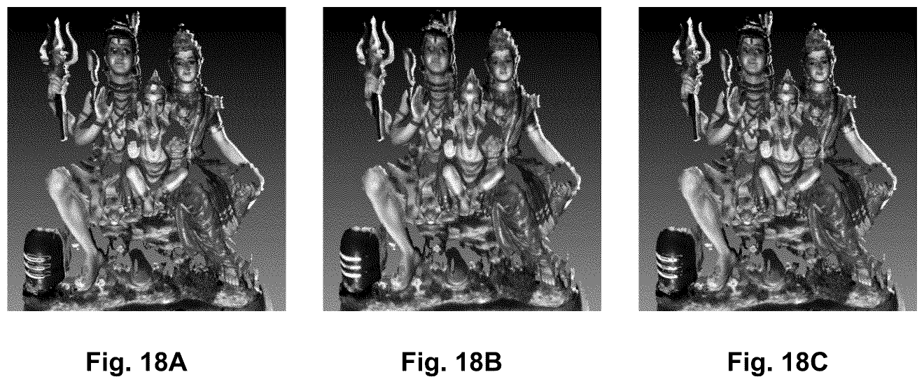

The noise model can be integrated into NeRF-based SLAM systems like PointSLAM, as shown in FIGS. 18A to 18C, by incorporating uncertainty weighting and ground truth depth refinement based on the noise model. Ground truth depth refinement is performed by calculating the expected value of depth from a 3×3 pixel neighbourhood using a Gaussian distribution that incorporates both axial and lateral noise.

σ_{z}(zₘᵢₙ)/σ₂(z) is used as the uncertainty weight, where σ_{z}(zₘᵢₙ) represents the axial noise at the minimum depth value. Moreover, we incorporate this axial noise as a dynamic lower bound in the point search radius of Point-SLAM. This dynamic lower bound is critical for ensuring that the search for neighboring points spans a sufficient spatial range, especially for distant points.

The noise modeling approach focuses primarily on high-resolution Zivid scans. Integrating the noise model significantly improves results when the reconstruction is performed on a very fine scale (0.2 mm or finer). This aligns well with traditional multi-view stereo and classical point-based reconstruction methods. Difficulties are encountered when applying the noise model to neural implicit approaches. When using Gaussian Splatting based SLAM, memory limitations restrict the resolution at which the noise model can be effectively utilized. When using NeRF-based SLAM, computational performance bottlenecks may be encountered.

Accordingly, the above demonstrates an empirically derived noise model of the RGB-D Zivid sensor, quantifying axial and lateral noise components relative to distance and surface angle. The benefit of the derived noise model is that integrating this model into 3D reconstruction pipelines leads to significant enhancements in both mapping and pose estimation accuracy. This enables the use of the method in advanced manufacturing, inspection, and other applications that require both high resolution and less measurement uncertainty. As those skilled in the art will appreciate, the process of determining a noise model may be repeated for a 3D reconstruction pipeline for example when working with a new or additional camera, materials, and/or surface properties such as colour, texture, reflectivity, etc.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1) A method for generating a noise model for a depth camera, the method including, in one or more processing devices:
a) acquiring data from the depth camera, the data being captured by performing measurements of a reference surface at multiple different known depths, wherein for each known depth, data are captured at multiple different known surface angles;
b) analysing the data captured at each known depth at each known surface angle to calculate measurement errors indicative of variations in depth measurements; and,
c) calculating a noise model by fitting the measurement errors to at least one function representing relationships between measurement errors and, measurement depths and surface angles, wherein the noise model is usable in analysing depth measurements performed using the depth camera and the at least one function includes
a combination of bivariate exponential and bivariate polynomial functions.

2) A method according to claim 1, wherein the method includes, in the one or more processing devices, analysing the data to calculate measurement errors for at least one of:
a) a part of the surface aligned with an imaging axis of the depth camera so that the noise model is an axial noise model; and,
b) parts of the surface spaced from the imaging axis of the depth camera so that the noise model is a lateral noise model.

3) A method according to claim 2, wherein the method includes, in the one or more processing devices:
a) analysing the data to calculate measurement errors indicative of variations in depth measurements spaced from the imaging axis of the depth camera; and,
b) calculating the lateral noise model by fitting the measurement errors to at least one lateral noise function.

4) A method according to claim 1, wherein the method includes, in one or more processing devices:
a) acquiring data from the depth camera using multiple different known imaging parameters, wherein for each known imaging parameter images are captured at multiple different known depths, and wherein the imaging parameters include at least one of:
(1) lighting conditions;
(2) an image exposure time;
(3) a number of images captured;
(4) depth camera aperture settings;
(5) depth camera resolution settings; and,
(6) depth camera dynamic range settings;
b) analysing the data captured for each imaging parameter at each known depth to calculate measurement errors indicative of variations in depth measurements; and,
c) calculating an imaging parameter noise model by fitting the measurement errors to at least one imaging parameter function.

5) A method according to claim 4, wherein the method includes, in the one or more processing devices, analysing the data to calculate measurement errors for at least one of:
a) a part of the surface aligned with an imaging axis of the depth camera so that the imaging parameter noise model is an axial noise model; and,
b) parts of the surface spaced from the imaging axis of the depth camera so that the imaging parameter noise model is a lateral noise model.

6) A method according to claim 4, wherein the method includes, in the one or more processing devices, determining the imaging parameters using at least one of:
a) the data;
b) camera data indicative of depth camera operation;
c) user input commands; and
d) signals from one or more additional sensors.

7) A method according to claim 1, wherein the reference surface includes a planar surface.

8) A method according to claim 7, wherein the measurement errors are calculated based on differences between depth measurements and a plane fitted to the planar surface.

9) A system for generating a noise model for a depth camera, the system including one or more processing devices configured to perform the method of claim 1.

10) A system according to claim 9, wherein the system includes a turntable that rotatably supports the reference surface, and wherein the one or more processing devices are further configured to control the turntable to position the reference surface at the known surface angles.

11) A system according to claim 9, wherein the system includes a robot arm, with the depth camera being movably mounted using the robot arm and wherein the one or more processing devices are further configured to control the robot arm to position the depth camera at the known depths.

12) A non-transitory computer-readable medium comprising computer-executable instructions that when executed perform a method for obtaining depths using a depth camera, the method including, in one or more processing devices:
a) acquiring data from the depth camera, the data being captured by performing measurements of a surface;
b) for a point on the surface, analysing the data to calculate an estimated depth and a corresponding estimated surface angle; and,
c) using at least one function of a noise model to calculate an error in the estimated depth based on the estimated depth and corresponding estimated surface angle, wherein the at least one function represents relationships between measurement errors and, measurement depths and surface angles as a combination of bivariate exponential and bivariate polynomial functions.

13) A non-transitory computer-readable medium according to claim 12, wherein the method includes, in the one or more processing devices:
a) for a point on the surface aligned with a camera axis, calculating the error in the estimated depth using an axial noise model; and,
b) for a point on the surface spaced from a camera axis, calculating the error in the estimated depth using a lateral noise model.

14) A non-transitory computer-readable medium according to claim 12, wherein the data includes data captured from different viewpoints and the method includes, in the one or more processing devices:
a) for a point on the surface, analysing the data from captured from multiple different viewpoints to obtain multiple estimated depths and corresponding estimated surface angles;
b) using at least one function of the noise model to calculate an error associated with each estimated depth based on the estimated depth and the corresponding estimated surface angle; and,
c) using the error to assign a weighting to each estimated depth, the weighting having a magnitude indicative of the error calculated for the estimated depth.

15) A non-transitory computer-readable medium according to claim 12, wherein the method includes, in the one or more processing devices:
a) determining an imaging parameter, wherein:
i) the imaging parameter includes at least one of:
(1) lighting conditions;
(2) an image exposure time;
(3) a number of images captured;
(4) depth camera aperture settings;
(5) depth camera resolution settings;
(6) an depth camera dynamic range; and,
b) using at least one function of an imaging parameter noise model to calculate an error in an estimated depth based on the estimated depth and the imaging parameter.

16) A non-transitory computer-readable medium according to claim 12, wherein the method includes, in the one or more processing devices, using the error to at least one of:
a) estimate an error for a measured depth for the point on the surface;
b) track movement of the depth camera relative to the surface;
c) reconstruct the surface;
d) perform coverage planning when scanning the surface;
e) perform filtering when reconstructing the surface;
f) perform a SLAM process;
g) generate a surface point cloud; and,
h) perform object recognition or classification.

17) A non-transitory computer-readable medium according to claim 12, wherein the method includes:
a) analysing the data to:
i) construct a surface model of the surface; and,
ii) determine a pose of the depth camera relative to the surface; and,
b) using the noise model to account for sensor noise and thereby:
i) construct a refined surface model indicative of the surface of the object; and,
ii) determined a refined pose of the sensor relative to the object.

18) A non-transitory computer-readable medium according to claim 12, wherein method includes, in the one or more processing devices:
a) generating the surface model using estimated depths obtained from data captured from one of multiple different viewpoints; and,
b) iteratively updating the surface model using estimated depths obtained from data captured at successive ones of the multiple different viewpoints to construct the refined surface model.

19) A non-transitory computer-readable medium according to claim 18, wherein method includes, in the one or more processing devices, iteratively updating the surface model using a weighting scheme in which weights are assigned to estimated depths based on errors calculated using the noise model.

20) A non-transitory computer-readable medium according to claim 19, wherein the weighting scheme is used to filter the surface model to reduce the impact of noisy data on the refined surface model.
